(19) United States
(12) Patent Application Publication
(10) Pub. No.: US 2003/0069710 A1
(43) Pub. Date: Apr. 10, 2003

(54) Method for quantifying the polar response of transducers

(76) Inventor: Earl Geddes, Northville, MI (US)

Correspondence Address: Earl R. Geddes, 43516 Scenic Lane, Northville, MI, 48167, US

(21) Appl. No.: 09/960,889

(22) Filed: Sep. 24, 2001

(51) Int. Cl. G01D 3/00

(52) U.S. Cl. 702/108

(57) ABSTRACT

A method and apparatus is disclosed for quantifying an acoustic transducer's directional response that has as its main feature a significant reduction in data complexity. Specific procedures are shown for sound radiating from a source in a flat baffle, a long column or a sphere. A method for extending this reduced representation to systems of transducers of any degree of complexity is also disclosed.

### BACKGROUND

1. Field of the Invention

The present invention relates to a method and apparatus for specifying the polar response of acoustical transducers.

2. Description of Prior Art

In the area of transducer design and development it is desirable to know the polar (directional) response of the device under consideration. The polar response is defined as the sound pressure level (SPL) exhibited in a free field at a given distance from the source as a function of the spherical polar angles θ and φ. (These angles may be defined differently in different cases, but in any case will always cover the same region of interest.) Knowledge of the polar response is required to accurately simulate, via a computer program or other such methodologies, the total field response of single, or more importantly, multiple transducer systems. Recently much importance has been placed on the polar response of systems as a measure of design quality. Further, an accurate simulation of the sound field of a room or auditorium requires an accurate and detailed description of the polar response of the systems placed in those venues.

The current approach to specifying this response is to measure the SPL at numerous points on a hypothetical sphere using standard acoustical measurement procedures. If an angular resolution of one degree and a frequency resolution of 10 Hz are desired (as recommend by the Audio Engineering Society) then a great many complex (magnitude and phase) numbers must be stored for later retrieval. For example the above resolution would require 90 angles by 2,000 frequency points or about 1.4 MB of computer storage to accommodate the specification of a single axi-symmetric driver in a planar baffle, by far the simplest case. If the driver or system is non-axi-symmetric (as most are) then this number goes up by more than two orders of magnitude (360 to 720 times). Even with today's large disk drive capacities and fast execution and transmission speeds this amount of data is prohibitive. Practical storage, calculation times and communication means (one user to another) are not possible with this amount of data.

It is therefore desirable to simplify the data load required for the specification of a driver or system's polar response without severely reducing its accuracy. By utilizing methods of specification that are more efficient and by taking into consideration characteristics of sound radiation that must apply to all transducers, the amount of data required for accurate polar specification can be reduced substantially.

Geddes discussed modal sound radiation from flat apertures in the paper “On the Use of the Hankel Transform for Sound Radiation” presented to the Audio Engineering Society Convention in San Francisco in October 1992 (Preprint #3428). In that paper I discussed the calculation load reduction that results from the use of a transform approach, which can be several orders of magnitude. What this paper did not describe, nor was it realized at the time, is that, similar to the improvement in calculation efficiency an improvement can also be realized in the amount of data which must be stored in order to describe a systems polar radiation response. This later aspect is, perhaps, more important than the former.

Some additional theory can be found in a paper by Weinreich and Arnold, “Method for measuring acoustic radiation fields”, J. Acous. Soc. Am., vol. 68(2), August 1980. This paper describes the expansion of a radiation field into spherical harmonics, or, as I call them in the general case, radiation modes. Weinreich does not describe geometries other than full spherical nor does he discuss how to handle the frequency variation aspects inherent in the transducer problem. He did realize that the data load could be reduced with this method since his concern was with other aspects of the technique.

This patent discloses a method and apparatus for representing the polar response data set in an equivalent set of modal radiation terms. Reduction factors up to 10,000 or more in the number of parameters that are required to completely describe a transducers polar response are conceivable. The technique is similar to spectral methods of data reduction commonly used in digital communications and MPEG techniques used for data reduction of video as well as audio signals (i.e. the well-known MP3 format).

### OBJECTS AND ADVANTAGES

Among the objects and advantages of the present invention are:

to provide a means to accurately describe a transducer's polar radiation pattern with a reduced set of data;

to lower computer resource loads in the computer utilization and manipulation of the polar response of a transducer;

to provide an efficient means of storing and or transmitting the complete specification of a transducer's polar radiation pattern;

to provide a means to create reduced data sets in the representation of the polar response of complex systems of transducers.

### DRAWING FIGURES

FIG. 1 shows a drawing of a preferred embodiment of the disclosed method of measurement.

FIG. 2 shows a flow diagram defining the general data reduction procedure.

FIG. 3 shows the measurement coordinate system for circular based preferred embodiments.

FIG. 4 shows the measurement coordinate system for the rectangular based preferred embodiments.

Reference Numerals in Drawings

| | |
|---|---|
| 10 | Transducer |
| 20 | Baffle |
| 30 | Measurement Microphone |
| 40 | Computer |

### SUMMARY

In accordance with the present invention, a method is disclosed for quantifying a transducer's directivity response that has as its main feature a significant reduction in data complexity. Specific procedures are shown for sound radiation from sources in a flat baffle, a long column or a sphere. The methods and apparatus required for creating this reduced representation of sound radiation as well as its application to systems of any degree of complexity are disclosed.

### DESCRIPTION

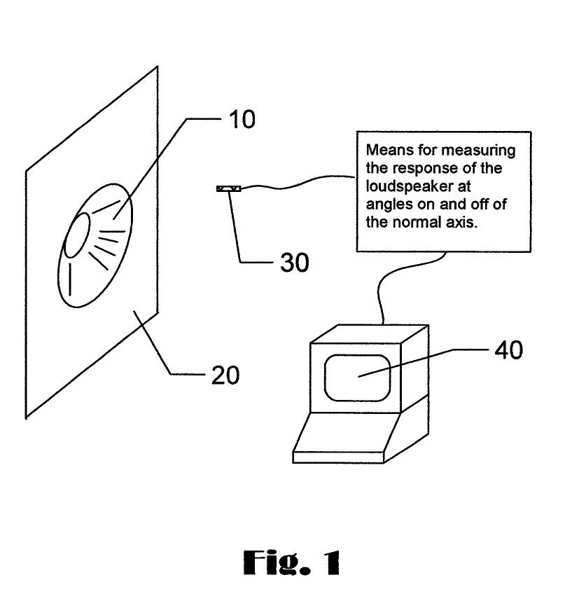

In the general case, one first measures the polar response using techniques that are well know to those in the art. An example of such a procedure is shown in FIG. 1. FIG. 1 shows a generic measurement setup wherein transducer 10 (the Device Under Test—DUT) is placed in a large baffle 20, although. a closed box can also be used with some limitations (which are well know to those skilled in the art). The polar response is measured in the traditional way, using microphone 30 attached to measurement system 40. The measurement system yields the pressure response data of the DUT at known frequencies and at field points at known angles and usually at a constant distance from the source.

The first step in the data reduction process is to expand the data taken above in terms of the “radiation modes” in a geometry that is most appropriate for the radiating device. In mathematical terms one finds the “best fit” equivalent of one function in term of another function or set of functions. Finding the correct geometry for this expansion depends on several aspects of the transducer or system being quantified. The first consideration is that of secondary diffraction such as occurs at a cabinet edge, etc. If this diffraction is represented in the measured data then the modal radiation fitting procedure will attempt to find a representation of it in terms of the modes that it has at its disposal. This may or may not be effective. If there is little or no diffraction in the measured data then almost any geometry will work, but there might still be aspects of the situation that would lead to the preference of one of the geometries over another.

Seldom is a single transducer the desired end result and as such multiple devices need to be combined to create a system. If these devices will all be combined in a common plane then either the circular disk or the square disk geometry would work well. In fact two different types of expansions can be combined if a common geometric definition is used (the two geometries mentioned above use different polar angle definitions. However, it is a trivial matter to convert one set to the other). If the devices will be combined along a line, to create a line array for instance, then the cylindrical expansion would likely work best. If the end product will be a clustered system then the spherical expansion may be the most appropriate. The point here is that any geometry can be used for almost any problem, although some may work better than others in a particular application. There are no hard and fast rules, but with experience users will come to know which geometry should be used in which applications.

The method for combining devices should also be discussed since it may not be obvious how this is achieved, although, it is actually a straightforward matter to combine multiple devices into a single system. The net result of a combination of devices is obtained as a weighted sum of individual devices. The weighting depends on two factors, both of which are vectors (complex numbers). The first is the voltage spectrum delivered to the device, i.e. the crossover. The second is a “Green's Function”, which accounts for the fact that the data was taken with the source located at the origin and not all of the devices being combined can actually be at that location. In fact, it is likely that none of them will be. The function that is used in this case is simply the vector difference between the Green's Function from the new source location to the field point and the Green's Function from the origin to the field point. This will yield the correction to the amplitude and phase that is required for sound radiation from a source that is not located at the origin when the data is given with that same source placed at the origin. Multiplying the data set that is reconstructed from the stored data for each device in the system by the two terms described above and then doing a complex sum over the devices will yield the desired result. One may also have to consider that the “normal” line may be different for different devices. This is simply a matter of using different polar angles in the reconstruction of the polar patterns.

The above procedure will yield a representation of an entire system of transducers as; a polar radiation data set; a vector to its location; its orientation angle; and a specification of its input voltage, for each transducer in the system. It is then a trivial mater to reconstruct the complex polar radiation patterns and frequency response for any system no matter how complex. The total size of this data set would be a small fraction of the data set required for this level of detail using traditional means of a specification.

The expansion of the measured data into a radiation modal representation is core to my invention. Although not trivial, this step is also not particularly difficult for those familiar with the theory of acoustic radiation. The techniques are purely mathematical and well know in the field of mathematics if not the field of transducer design. The only difficulty that one might encounter in this expansion is when there is very little sound radiated at a frequency under consideration. This occurs primarily at low frequencies, although it can also occur at higher frequencies. At these unique frequencies there is not enough data to fit the modes to and there exists an ambiguity or singularity in the data set. Special numerical matrix techniques (such as Singular Value Decomposition, SVD) may be required to get around this problem at these frequencies.

As an alternate view of this step, it is interesting to note that the modal model gives us, in essence, a set of vibration modes of the source that yields the measured data set. These vibration modes are, if not the same as similar to, the actual vibrations that occurred to produce the radiated sound field that was measured. So, in effect, what is being retained is an equivalent model of the source vibration and not the radiated sound field, but knowing that we can readily recreate the radiated field from this data set using simple radiation formulas applicable to these modes. Since the source has much smaller dimensions than the radiated field itself the data required to describe it can be reduced substantially.

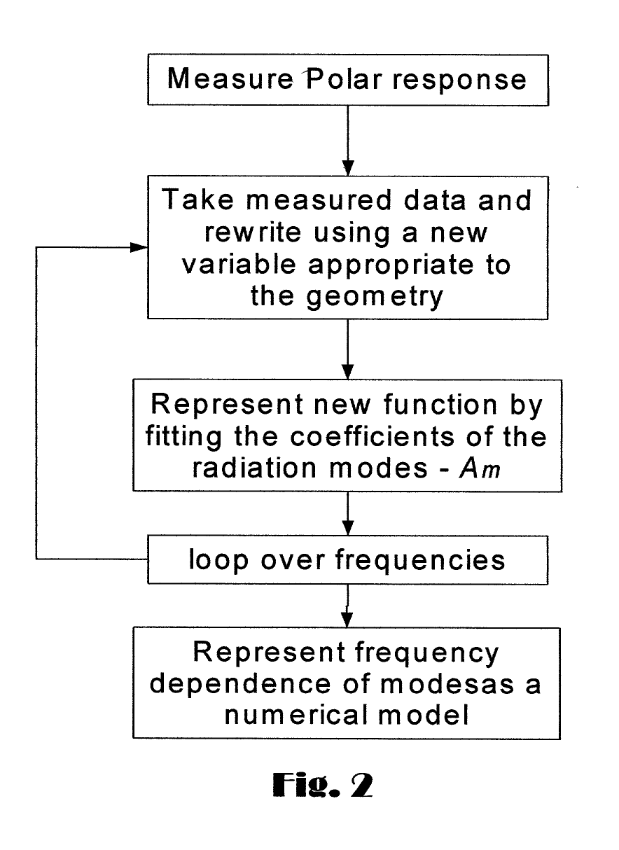

Basically the algorithm is performed as shown in FIG. 2. At each frequency the polar response data is expanded in the radiation modes that are appropriate to the application Then the frequency dependence of each modal coefficient is further modeled to yield the final fully reduced data set.

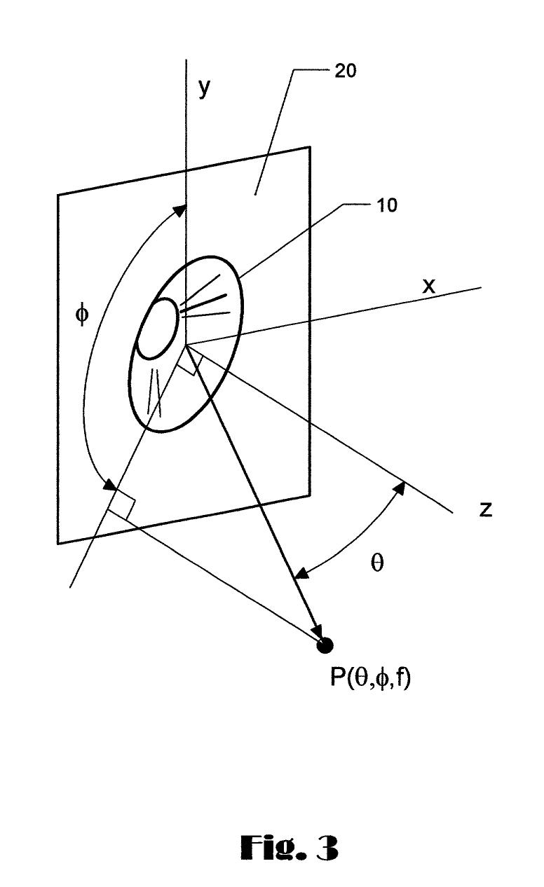

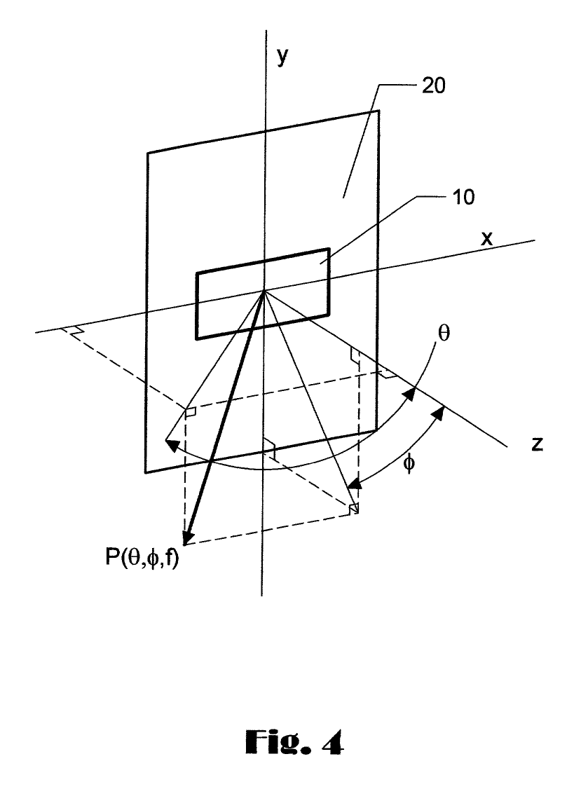

FIG. 3 shows the definitions of the polar angles used in the circular disk and spherical geometries and FIG. 4 shows the angle definitions for the rectangular disk and the cylindrical cases. They are different definitions but both cover the exact same surface and can easily be transform from one to the other.

As a first preferred embodiment consider the follow specific example of a circular disk in an infinite baffle (a very common situation). In the case of the circular aperture the data reduction is achieved by first re-plotting, at a specific frequency, the polar response as a function of a new variable ρ=ka sin(θ), where k=2π·f/c, f is the frequency and c is the speed of sound, θ is the angle to the field point at which the pressure is measured and the variable a is the radius of the source (the aperture) under test. The variable a is the “assumed” radius of the source and should be larger than the actual source, although the modal summation will converge more rapidly the closer the assumed value is to the actual value. This function, which I will call P(ρ) can then be expanded into an equivalent set of functions of the form:

$$P ( ρ ) = 2 π \cdot a {\sum }_{m} {A}_{m} \frac{ρ \cdot a \cdot {J}_{1} ( ρ \cdot a )}{{( ρ \cdot a )}^{2} - {( π \cdot {α}_{m} )}^{2}} \qquad ( 1$$

where J₁ is the Bessel function of order one and aₘ are the m zeros of the Bessel function of order zero. Eq. 1 is equivalent to a Hankel transform of the data as described above. The Aₘ coefficients in this equation can be calculated on a computer to find those values of Aₘ which “best fit” Eq. 1 at the specific frequency under consideration.

It will be stated, but not proven, that several very important characteristics can be claimed about the series expansion in Eq. 1. These characteristics derive from the fact that Eq. 1 is the Hankel transform of a series that is both orthogonal and complete. Since the Hankel transform is both invertible and linear, the series that results from this transformation will also be both orthogonal and complete. This is very important since it means that the coefficients Aₘ(f) will be unique regardless of the mechanism used to calculate them. It also means that for any polar response function there exists a unique set of Aₘ(f)'s that will exactly describe this function in a “best fit” sense.

If Aₘ(f) were independent of frequency then the storage requirements would simply be a single complex number for the amplitude of each radiation mode. There would then be only five numbers (for example) to accurately quantify the transducers' radiation characteristics to a very high frequency. However in the general case, resonance modes of the cavity in front of the transducer as well as vibration modes in the mechanical structure itself will cause the radiation modes to be frequency dependent.

When the Aₘ(f)'s are frequency dependent then it is desirable to accurately model this frequency dependence with as few coefficients as possible. There are well known techniques for doing this modeling, for example, using Auto Regressive-Moving Average (ARMA) techniques, Prony, FFT, etc. The FFT response can be used, however it is well known that it is very inefficient in terms of data reduction. Different techniques can be used for different modes, which would allow, for example, the axial response, which can only depend on the lowest order mode, to be represented with say an FFT, while higher modes, which contain the variations of the response with angle, to be represented with a simpler frequency model. These frequency-modeling techniques are all well described in the art and not in themselves an invention, however, when combined with the radiation modal expansion techniques being discussed herein these data reduction techniques represent an extremely efficient method for reducing the total amount of data required to accurately describe the polar response of a radiating system.

Assuming five aperture modes in the modal expansion and each modes frequency response is modeled by eight poles and zeros, the data model would require (5 modes×16 poles/zeros×8 bytes per coefficient−single precision) 640 bytes of storage for an axi-symmetric polar response. This is a reduction in the data storage requirement of over 2000 times! The accuracy of the modeled data can be expected to be comparable to the measured data to an accuracy of a few dB, except perhaps at points of very low sound radiation, i.e. nodes. This is because even small errors can cause large dB errors when the net result is supposed to be zero, More importantly, though, the phase will be very stable and accurate, a significant problem with measured data.

When modeling the frequency response of the radiation modes it is not usually required to model the low frequency high pass filter response that is a characteristic of every transducer. This response is often well characterized by the standard Thiele-Small parameters and need not be duplicated. The response of interest here is the deviation of the actual response from the passband efficiency predicted by the Thiele-Small values. Fortunately, this means that the polar response characteristics that need to be modeled by the ARMA procedure (or whatever procedure is used) will be basically flat at lower frequencies. Very low frequencies (long impulse responses) are notoriously hard to model with typical data reduction techniques based on time domain representations.

When the polar response is not axi-symmetric there are two methods that can be used. If the source is more nearly round then the preferred method is to continue to use the Hankel transform method but with angular variations expressed as expansions in Sine's and/or Cosines. This technique is also mentioned in my paper on Hankel transforms. With this method the radiation mode values will now be a two dimensional array of numbers, wherein (in general) each element of matrix will be frequency dependent.

Theoretically no more data points are required than the number of modes to be extracted, but the additional data will always be useful in the numerical reduction phase. For the non-axi-symmetric case data must also be taken around a circle at some constant value of theta. This theta value is not critical so long as it is not a nodal line of one of the radiation modes. However, since the radiation modes nodal circles move with frequency there is likely to be some frequency for which this circle is a nodal line for some mode. To be safe, therefore, it is suggested that two or more circles be used in the calculations.

The axi-symmetric radiation modes are first calculated as described above from the data taken along an arc from the axis to the baffle. The differences in the measured data and the axi-symmetric representation are then fitted to the non-axi-symmetric set of equations as can be found in Morse, Vibration and Sound, Eq. 28.4, pg. 330. The details of this expansion will not be covered since it would follow along lines identical to those discussed in the axi-symmetric case.

The data storage requirements for the full polar response of a circular source might require 5θ modes•5ψ modes•16 poles/zeros•8 bytes per coefficient, or 3200 bytes of storage. This is a reduction of more than 15,000 times the data requirements when compared to current techniques.

An additional preferred embodiment occurs when a rectangular geometry of radiators, such as one would have for a square mouth horn or a square array of sources, is being measured, or in the case of a highly non-axi-symmetric situation. In this embodiment one needs data on at least two orthogonal circular arcs, which intersect at a point on the normal to the assumed source at its center. It is convenient if these two arcs are parallel to the edges of the assumed rectangular source. As in the previous embodiment, the polar data is first transformed by using a conversion z=k·a·sin(θ) for the arc parallel to the edge of length 2a and z=k·b·sin(φ) for the other arc. The definitions of θ and φ can be found in FIG. 4. They are the angle away from the normal (the z axis) in the x-z plane, and the angle away from the normal in the y-z plane. The transformed polar data is then best fit to them terms:

$${g}_{m} ( z ) = \frac{z \cdot sin ( z )}{{( m \cdot π )}^{2} - {z}^{2}} \qquad 2 )$$

for each arc separately.

The functions described in Eq. 2 are (to my knowledge) unknown. Their derivation is not trivial and it cannot be said to be obvious to one skilled in the art. I have posted this derivation, as well as plots of them, on my web site http://www.gedlee.com/derive_GL.htm as a reference. Their similarity to the functions in Eq. 1 should be noted, but so should the differences. The equation above was derived under the assumption of symmetry in both the x and y directions. This symmetry is assumed since it was felt that the added complexity of the completely arbitrary case was not worth developing here. It should be noted that it is envisioned that the completely arbitrary case (no symmetry) would not be much more difficult to actually implement in practice than the symmetric case, even though it is much more difficult to describe. The derivation and implementation of techniques for a non-symmetric situation would follow along exactly the same lines as that shown here except that both sine and cosine terms would have to be retained in the expansions.

In general the rectangular source will have a two dimensional array of coefficients as shown below:

Ao₀o AO, A₀o₂ Ao,₃

AlO All AI,₂ AI,₃

A₂,₀ Al,₂ A₂,₂ A₂,₃

A₃,₀ AI,₃ A₃,₂ A₃,₃

(where only 16 terms have been shown). The procedure described above will only determine the coefficients with a zero (0) in them, namely the first row and column. To obtain the other coefficients one needs data at angles (in the x-y plane) between those already taken. As a simplification consider the angle φ=tan⁻¹(b/a). Taking data along an arc with this angle relative to the x axis and then transforming the data by using

$$z = k \cdot ( \frac{a \cdot b}{{a}^{2} + {b}^{2}} ) sin ( θ ) ,$$

sin(θ), θ now being the angle away from the z axis along this new line in the x-y plane, the diagonal coefficients in the above equation can then be determined using Eq. 2, to fit the data not accounted for by the terms already calculated. To determine the coefficient A_{2,1} one would take data along a line at an angle of φ=tan⁻¹(2·b/a). The general procedure is easy to see from these examples.

In the general case the expansion is done as G_{m,n}(Xₘ, Yₙ)=gₘ(X)·gₙ(Y) where the variables of transformation are X=k·a·sin(θ)·cos(φ) for the x direction and Y=k·b·sin(θ)·sin(φ) for the y direction. The functions gₘ(z) are given in Eq. 2. As in all other cases, modeling the frequency dependence of the radiation mode coefficients by means described above can reduce the data load.

Another preferred embodiment exists for a source that is best represented as a section of a cylinder. This would occur, for example, in a line array or a source being used in a line array. In this case the radiation pattern would be expanded in terms of a series of sine's and cosines, i.e. a Fourier series for the angular direction, θ. If the source is symmetric around the cylinder then only cosine terms will exist. The vertical radiation is expanded in a set of functions gₘ(z) as shown in Eq. 2 except that z=k·a·sin(φ) in this case, where a is the height of the source and φ is the angle away from the normal in the plane of the axis and the normal. Exactly like the rectangular case there is a full matrix of coefficients and data needs to be taken at those points that yield the required information. The procedure is a direct extension of that discussed above and its implementation will be apparent to those skilled in the art. Fitting a model to the frequency dependence of the coefficients would once again reduce the data requirements.

The final preferred embodiment would be for a spherical source. In essence, any finite source can be expanded in this manner but for certain common geometries the previous embodiments are preferred, because, in a mathematical sense, they will converge more rapidly resulting in a smaller number of radiation modes for equivalent accuracy. The radiation modal expansion for the spherical case is well described by Weinreich and will not be elaborated on here except for one particular situation that Weinreich did not discuss.

Consider a rigid plane inserted through a rigid sphere such that the origin of the sphere lies in this plane and such that there is symmetry of the source about two planes also passing through the origin of the sphere and perpendicular to the first plane. This may sound unlikely, but it is actually quite a common situation. It simply means that there are two planes of symmetry of the source, which nearly all transducers have. If a source mounted in a rigid hemisphere which is itself mounted on a rigid baffle such that the planes of symmetry lie as described above then the data requirements can be further reduced. These later requirements can always be met for a symmetrical source. The data requirements are halved for the axi-symmetric case (which is only one dimensional and not mentioned by Weinreich, but would be apparent to those skilled in the art) and reduced by a factor of four for the non-axi-symmetric case. This is because only odd coefficients will appear in the expansion as a result of this symmetry and the reflecting plane. Since the general spherical case can require many terms for convergence this extra reduction in data may be desirable.

Finally the frequency dependence of the spherical expansion coefficients can be modeled, as discussed above, in order to reduce the data requirements.

One final point should be made. It may well occur that some modes will require more coefficients in the frequency response expansion than other modes. For instance the axial response is always the “average” response of the source. This is the most important mode, the zero order mode, and as such would more than likely need a higher degree of resolution than the other modes. It will also always occur that there will be an insignificant mode contribution of the higher order modes below some higher frequency. This later condition must occur since the modal radiation impedance's exhibit a form of “cutoff” below a particular frequency, The frequency differs for each mode going higher as the mode number goes higher. This “cutoff” effect would further reduce the data requirements of the system.

I claim as my invention:

1. A method for reducing the data required to represent the polar response of a sound radiating device comprising:
a means for measuring the polar response of the device under test and;
a means for calculating a modal representation of said polar response and;
a means for representing the frequency dependence of said modal representation of said polar response and;
a means for storing said reduced data set.

2. The invention as described in claim 1 wherein:
said modal representation is in terms of a set of Bessel Functions and Cosine functions defined inside of a circle.

3. The invention as described in claim 1 wherein:
said modal representation is in terms of a set of Sin and Cosine Functions in two orthogonal axes defined inside of a rectangle.

4. The invention as described in claim 1 wherein:
said modal representation is in terms of a set of Sine and Cosine Functions defined inside of a rectangular section of a cylinder.

5. The invention as described in claim 1 wherein:
said modal representation is in terms of Spherical Harmonics defined on the surface of a sphere.

6. An apparatus for storing the data required to represent the polar response of a sound radiating device comprising:
a means for measuring the polar response of the device under test;
a means for calculating a modal representation of said polar response;
a means for representing the frequency dependence of said modal representation of said polar response and
a means for storing said reduced data set.

7. The invention as described in claim 6 wherein:
said modal representation is in terms of a set of Bessel Functions and Cosine functions defined inside of a circle.

8. The invention as described in claim 6 wherein:
said modal representation is in terms of a set of Sin and Cosine Functions in two orthogonal axes defined inside of a rectangle.

9. The invention as described in claim 6 wherein:
said modal representation is in terms of a set of Sine and Cosine Functions defined inside of a rectangular section of a cylinder.

10. The invention as described in claim 6 wherein:
said modal representation is in terms of Spherical Harmonics defined on the surface of a sphere.
